(19) United States
(12) Patent Application Publication
(10) Pub. No.: US 2008/0141273 A1
(43) Pub. Date: Jun. 12, 2008

(54) Accessing Application Message Data In A Messaging Environment

(76) Inventor: Kenneth W. Borgendale, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/608,904

(22) Filed: Dec. 11, 2006

(51) Int. Cl. G06F 3/00

(52) U.S. Cl. 719/313

(57) ABSTRACT

Methods, systems, and products are disclosed for accessing application message data in a messaging environment that include: establishing a message model on a message sending device, the message model specifying a message format for interpreting application messages and including one or more field specifications, each field specification specifying a message field for storing data in the messages and including field characteristics, at least one of the field specifications specifies a sequence number message field for storing a sequence number; calculating a sequence field code in dependence upon the field specification for the sequence number message field; creating an application message according to the message model; receiving, in a transport engine of the message sending device, the application message and the sequence field code; and accessing, by the transport engine of the message sending device, the sequence number message field in the application message in dependence upon the sequence field code.

### BACKGROUND OF THE INVENTION

1. Field of the Invention

The field of the invention is data processing, or, more specifically, methods, systems, and products for accessing application message data in a messaging environment.

2. Description of Related Art

Messaging environments are generally available to provide data communication between message sending devices and message receiving devices using application messages. An application message is a quantity of data organized into one or more data fields and is passed from a message producer installed on a message sending device to a message consumer installed on a message receiving device. An application message is a form of message recognized by application software operating in the application layer of a data communication protocol stack—as contrasted for example with a transport message or network message which are forms of messages recognized in the transport layer and the network layer respectively. An application message may represent, for example, numeric or textual information, images, encrypted information, and computer program instructions.

For an example of an application message, consider a financial market data environment. A financial market data environment is a data processing environment used to communicate information about financial markets and participants in financial markets. In a financial market data environment, an application message is commonly referred to as a ‘tick’ and includes financial market data such as, for example, financial quotes or financial news. Financial quotes include bid and ask prices for any given financial security. A ‘bid’ refers to the highest price a buyer is willing to pay for a security. An ‘ask’ refers to the lowest price a seller is willing to accept for a security.

Application messages in current messaging environments are typically created and interpreted according to a message model. The message model specifies the message format used to interpret the application messages. An application message is composed of one or more message fields, each message field is a message field or a message data structure composed of multiple message fields or other data structures. The message model includes information regarding the format and other characteristics of each of the message fields in application messages. For example, the message model may specify the type of each message field, the offset of each message field from the beginning of the message, the size of each message field, and the name of each message field.

When a message sending device transmits application messages to a message receiving device, the transport engines installed on the devices often use the values stored a sequence number message field of the application messages to ensure reliable delivery of the messages. Because the application messages are created in the application layer of the network protocol stack, the transport engine typically does not have knowledge regarding the format of the application messages. Transport engines in current messaging environments, therefore, typically receive a copy of the value for the sequence number message field along with each application message from application software. Such transport engines then wrap each application message in a transport layer wrapper and insert the received value for the sequence number message field in the header of the transport layer wrapper. The drawback of inserting the value for the sequence number message field in the header of a transport layer wrapper is that the overall size and complexity of the transport layer wrapper containing the application message is increased. In messaging environments such as, for example, a financial market data environment, where large numbers of application message are transmitted from one device to another, even small increases in the overall size and complexity of the transport layer wrapper containing the application message may reduce the overall system performance. As such, readers will therefore appreciate that room for improvement exists for accessing application message data in a messaging environment.

Additional areas in current messaging environments in which room for improvement exists include the area of transmitting application messages that contain default and constant values. Because default and constant values for a particular type of application message do not change from one message to another, redundant data is typically transmitted in each of the application messages. Such redundant data increases the size and complexity of the application messages, and as mentioned above, may reduce the overall system performance. As such, readers will therefore appreciate that room for improvement exists for accessing default and constant data in application messages in a messaging environment.

### SUMMARY OF THE INVENTION

Methods, systems, and products are disclosed for accessing application message data in a messaging environment that include: establishing a message model on a message sending device, the message model specifying a message format for interpreting application messages, the message model comprising one or more field specifications, each field specification specifying a message field for storing data in the application messages, each field specification comprising field characteristics, at least one of the field specifications specifies a sequence number message field for storing a sequence number in each of the application messages; calculating, by the message sending device, a sequence field code for the message model in dependence upon the field specification for the sequence number message field; creating, by the message sending device, an application message according to the message model; receiving, in a transport engine of the message sending device, the application message and the sequence field code; and accessing, by the transport engine of the message sending device, the sequence number message field in the application message in dependence upon the sequence field code.

Methods, systems, and products are also disclosed for accessing application message data in a messaging environment that include: establishing a message model on a message receiving device, the message model specifying a message format for interpreting application messages, the message model comprising one or more field specifications, each field specification specifying a message field for storing data in the application messages, each field specification comprising field characteristics, at least one field specification specifies a default message field, the field characteristics for the default message field specify a default value; receiving, in a messaging module of the message receiving device from a requesting module, a request for a value from a specific message field of an application message, the application message created according to the message model without the default message field; determining, by the messaging module, whether the specific message field is the default message field; and providing, by the messaging module to the requesting module, the default value specified in the message model if the specific message field is the default message field.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for accessing application message data in a messaging environment according to exemplary embodiments of the present invention.

FIG. 2 sets forth a block diagram of automated computing machinery comprising an exemplary message receiving device useful in accessing application message data in a messaging environment according to exemplary embodiments of the present invention.

FIG. 3 sets forth a flowchart illustrating an exemplary method for accessing application message data in a messaging environment according to exemplary embodiments of the present invention.

FIG. 4 sets forth a flowchart illustrating a further exemplary method for accessing application message data in a messaging environment according to exemplary embodiments of the present invention.

FIG. 5 sets forth a flowchart illustrating a further exemplary method for accessing application message data in a messaging environment according to exemplary embodiments of the present invention.

FIG. 6 sets forth a flowchart illustrating a further exemplary method for accessing application message data in a messaging environment according to exemplary embodiments of the present invention.

### DETAILED DESCRIPTION OF EXEMPLARY EMBODIMENTS

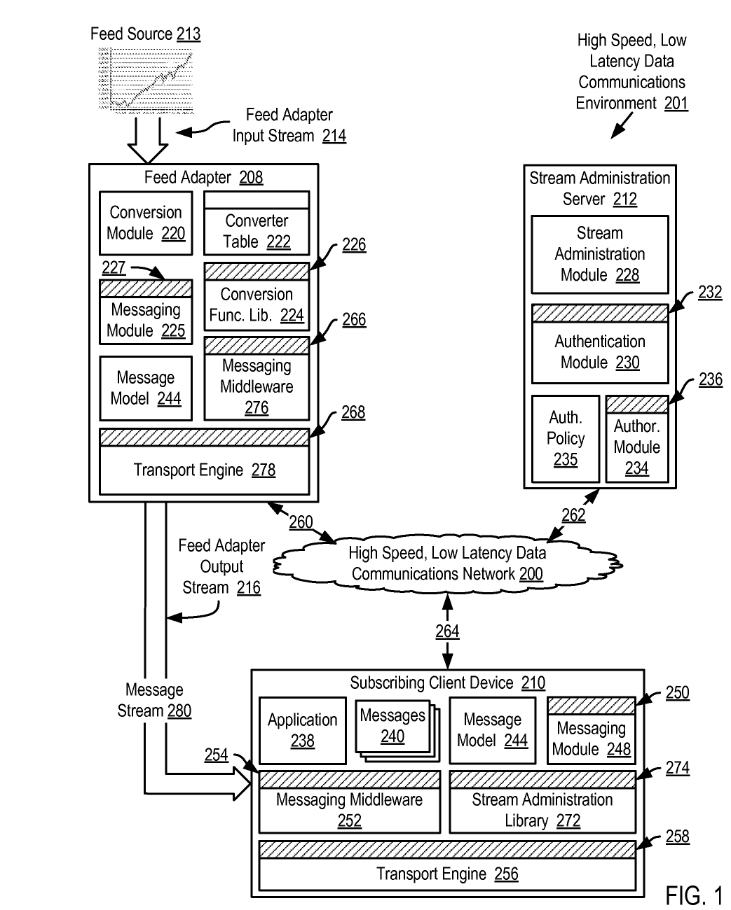

Exemplary methods, systems, and products for accessing application message data in a messaging environment according to embodiments of the present invention are described with reference to the accompanying drawings, beginning with FIG. 1. FIG. 1 sets forth a network diagram illustrating an exemplary system for accessing application message data in a messaging environment according to embodiments of the present invention. The system of FIG. 1 operates generally to access application message data in a messaging environment according to embodiments of the present invention as follows: A message model (244) is established on a message sending device (208). The message model (244) specifies a message format for interpreting application messages and includes one or more field specifications. Each field specification specifies a message field for storing data in the application messages and includes field characteristics. At least one of the field specifications specifies a sequence number message field for storing a sequence number in each of the application messages. The message sending device (208) calculates a sequence field code for the message model (244) in dependence upon the field specification for the sequence number message field. The message sending device (208) creates an application message according to the message model (244). A transport engine (278) of the message sending device (208) receives the application message and the sequence field code. The transport engine (278) of the message sending device (208) accesses the sequence number message field in the application message in dependence upon the sequence field code. A transport engine (256) of a message receiving device (210) may receives the application message from the message sending device (208). The transport engine (256) of the message receiving device (210) may access the sequence number message field in the application message in dependence upon the sequence field code. In the exemplary system of FIG. 1, the message sending device (208) is implemented as a feed adapter, and the message receiving device (210) is implemented as a subscribing client device.

The system of FIG. 1 may also operate generally to access application message data in a messaging environment according to embodiments of the present invention as follows: The message model (244) is established on the message receiving device (210). At least one field specification of the message model (244) specifies a default message field. The field characteristics for the default message field specify a default value. A messaging module (248) of the message receiving device (210) receives a request for a value from a specific message field of an application message from a requesting module. The application message is created according to the message model without the default message field. The messaging module (248) of the message receiving device (210) determine whether the specific message field is the default message field. The messaging module (248) of the message receiving device (210) provides the default value specified in the message model to the requesting module if the specific message field is the default message field. In the exemplary system of FIG. 1, the requesting module is any software component that requests services from the messaging module (248) installed on the subscribing client device (210).

The high speed, low latency data communications environment (201) illustrated in FIG. 1 includes a high speed, low latency data communications network (200). The network (200) includes a feed adapter (208), a stream administration server (212), and a subscribing client device (210), as well as the infrastructure for connecting such devices (208, 212, 210) together for data communications. The network (200) of FIG. 1 is termed ‘high speed, low latency’ because the application messages sent between devices connected to the network (200) on message streams administered by the stream administration server (212) bypass the stream administration server (212). For example, the application messages on the message stream (280) from the feed adapter (208) to the subscribing client device (210) bypass the stream administration server (212). Although such messages are not delayed for processing in the stream administration server (212), the stream administration server (212) retains administration of the stream (280) between devices connected to the high speed, low latency data communications network (200).

Further contributing to the ‘high speed, low latency’ nature of network (200), readers will note that the network (200) does not include a router, that is a computer networking device whose primary function is to forward data packets across a network toward their destinations. Rather, each device (208, 212, 210) provides its own routing functionality for data communication through a direct connection with the other devices connected to the network (200). Because the network (200) does not include a computer networking device dedicated to routing data packets, the network (200) of FIG. 1 may be referred to as a ‘minimally routed network.’ Although the exemplary network (200) illustrated in FIG. 1 does not include a router, such a minimally routed network is for explanation only. In fact, some high speed, low latency networks useful in accessing application message data in a messaging environment according to embodiments of the present invention may include a router.

The high speed, low latency data communications environment (201) depicted in FIG. 1 includes a message stream (280). A message stream is a data communication channel between a communications endpoint of a sending device and a communications endpoint of at least one receiving device. A communications endpoint is composed of a network address and a port for a sending device or a receiving device. A message stream may be implemented as a multicast data communication channel. In a multicast data communication channel, a one-to-many relationship exists between a destination address for a message and the communication endpoints of receiving devices. That is, each destination address identifies a set of communication endpoints for receiving devices to which each message of the stream is replicated. A multicast data communication channel may be implemented using, for example, the User Datagram Protocol (‘UDP’) and the Internet Protocol (‘IP’). In addition to a multicast data communication channel, the message stream may be implemented as a unicast data communication channel. In a unicast data communication channel, a one-to-one relationship exists between a destination address for a message and a communication endpoint of a receiving device. That is, each destination address uniquely identifies a single communication endpoint of single receiving device. A unicast data communication channel may be implemented using, for example, the Transmission Control Protocol (‘TCP’) and IP.

The exemplary system of FIG. 1 includes a stream administration server (212) connected to the high speed, low latency data communications network (200) through a wireline connection (262). The stream administration server (212) of FIG. 1 is a computer device having installed upon it a stream administration module (228), an authentication module (230), an authorization module (234), and an authorization policy (235). A stream administration module (228) is a software component that includes a set of computer program instructions configured for accessing application message data in a messaging environment according to embodiments of the present invention. The stream administration module (228) operates generally for accessing application message data in a messaging environment according to embodiments of the present invention by brokering establishment of a message stream (280) from the message sending device to a message receiving device. The message stream (280) provides the application messages to the message receiving device (210) from the message sending device (208).

The authentication module (230) of FIG. 1 is a set of computer program instructions capable of providing authentication security services to the stream administration module (228) through an exposed authentication application programming interface (‘API’) (232). Authentication is a process of verifying the identity of an entity. In the exemplary system of FIG. 1, the authentication module (230) verifies the identity of the subscribing client device (210). The authentication module (230) may provide authentication security services using a variety of security infrastructures such as, for example, shared-secret key infrastructure or a public key infrastructure.

The authorization module (234) of FIG. 1 is a set of computer program instructions capable of providing authorization security services to the stream administration module (228) through an exposed authorization API (236). Authorization is a process of only allowing resources to be used by resource consumers that have been granted authority to use the resources. In the example of FIG. 1, the authorization module (234) identifies the application messages that the subscribing client device (210) is authorized to receive on the message stream (280). The authorization module (234) of FIG. 1 provides authorization security services using an authorization policy (235). The authorization policy (235) is a set of rules governing the privileges of authenticated entities to send or receive application messages on a message stream. In a financial market data environment, for example, an authenticated entity may be authorized to receive application messages that include financial quotes for some financial securities but not other securities. The authorization policy (235) may grant privileges on the basis of an individual entity or an entity's membership in a group.

In the exemplary system of FIG. 1, feed adapter (208) is connected to the high speed, low latency data communications network (200) through a wireline connection (260). The feed adapter (208) is a computer device having the capabilities of converting application messages received on a feed adapter input stream (214) having a first format to application messages having a second format for transmission on a feed adapter output stream (216) to subscribing client devices. The feed adapter input stream (214) is a message stream from a feed source to the feed adapter (208). The feed adapter output stream (216) is a message stream administered by the stream administration server (212) from the feed adapter (208) to the subscribing client device (210).

In the example of FIG. 1, the feed adapter (208) receives application messages on the feed adapter input stream (214) from a feed source (213). The feed source (213) is a computer device capable of aggregating data into application messages and transmitting the messages to a feed adapter. In a financial market data environment, for example, a feed source (213) may be implemented as a feed source controlled by the Options Price Reporting Authority (‘OPRA’). OPRA is the securities information processor for financial market information generated by the trading of securities options in the United States. The core information that OPRA disseminates is last sale reports and quotations. Other examples of feed sources in financial market data environment may include feed sources controlled by the Consolidated Tape Association (‘CTA’) or The Nasdaq Stock Market, Inc. The CTA oversees the dissemination of real-time trade and quote information in New York Stock Exchange and American Stock Exchange listed securities. The Nasdaq Stock Market, Inc. operates the NASDAQ Market Center_{SM} which is an electronic screen-based equity securities market in the United States. In a financial market data environment, a feed adapter input stream is referred to as a ‘financial market data feed.’

The feed adapter (208) of FIG. 1 has installed upon it a conversion module (220), a converter table (222), conversion function library (224), a messaging module (225), a message model (244), messaging middleware (276), and a transport engine (278). The conversion module (220) is a set of computer program instructions for converting application messages received on the feed adapter input stream (214) having a first format into application messages (240) having a second format for transmission to subscribing devices on the feed adapter output stream (216).

The conversion module (220) converts application messages from the first format to the second format according to the converter table (222). The converter table (222) of FIG. 1 is a data structure that specifies the converter functions capable of converting the application message from one format to another format. Utilizing multiple converter tables, the conversion module (220) may convert messages from a variety of input formats to a variety of output formats. In the example of FIG. 1, the converter table (222) specifies the converter functions capable of converting the application message received from the feed adapter input stream (214) having the first format to application messages (240) having the second format for transmission to subscribing client devices on the feed adapter output stream (216). The converter table (222) of FIG. 1 may be implemented using a structured document such as, for example, an eXtensible Markup Language (‘XML’) document.

The conversion function library (224) of FIG. 1 is a loadable software module that contains one or more converter functions capable of converting data fields in an application message from one format to another format or converting values of data fields from one value to another value. The converter functions contained in the conversion function library may, for example, convert a 16-bit integer to a 32-bit integer, convert a number stored in a string field to a 64-bit double floating point value, increase the value of one data field by one, or any other conversion as will occur to those of skill in the art. The conversion module (220) accesses the converter functions through a set of converter function APIs (226) exposed by the converter functions of the conversion function library (224). In the example of FIG. 1, the conversion function library (224) may be implemented as dynamically linked libraries available to the conversion module (220) at runtime, statically linked libraries linked into the conversion module (220) at compile time, dynamically loaded Java classes, or any other implementation as will occur to those of skill in the art.

In the example of FIG. 1, the application messages (240) transmitted by the feed adapter (208) have a format specified in a message model (244). The message model (244) is metadata that defines the structure and the format used to create, access, and manipulate the application messages (240) converted from the application messages (not shown) received from the feed source (213). That is, the message model (244) specifies a message format for interpreting application messages and includes one or more field specifications. Each field specification specifies a message field for storing data in the application messages and includes field characteristics of the message field. In the example of FIG. 1, at least one of the field specifications specifies a sequence number message field for storing a sequence number in each of the application messages and at least one field specification specifies a default message field. The field characteristics for the default message field specify a default value for the default message field. In the example of FIG. 1, the message model (244) is established on both the feed adapter (208) and the subscribing client device (210) by the stream administration server (212) when the stream administration server (212) brokers a message stream to a subscribing client device. A message model may be implemented using a structured document, such as, for example, an XML document, a Java object, C++ object, or any other implementation as will occur to those of skill in the art.

In the example of FIG. 1, the conversion module (220) and the converter functions of the conversion function library (224) process the data contained in the application messages (240) using the messaging module (225). The messaging module (225) is a software module that includes a set of functions for creating, accessing, and manipulating messages (240) according to a message model (244). The messaging module (225) is accessible to the conversion module (220), the converter functions of the conversion function library (224), and the messaging middleware (276) through a message API (227) exposed by the messaging module (225).

The messaging module (225) in the exemplary system of FIG. 1 also includes a set of computer program instructions for accessing application message data in a messaging environment according to embodiments of the present invention. The messaging module (225) of FIG. 1 operates generally for accessing application message data in a messaging environment according to embodiments of the present invention by calculating a sequence field code for the message model (244) in dependence upon the field specification for the sequence number message field, and creating an application message according to the message model (244) such that the application message includes the sequence field code. The sequence field code is utilized by a transport layer component to identify the characteristics of the sequence number message field in the application message as explained below in further detail.

Before the conversion module (220) of FIG. 1 performs data processing on the application messages, the conversion module (220) receives application messages (not shown) having a first format from the feed source (213). The conversion module (220) of FIG. 1 may receive the source stream messages through a receiving transport engine (not shown) of the feed adapter (208). The receiving transport engine is a software module that operates in the transport layer of the network stack and may be implemented according to the TCP/IP protocols, UDP/IP protocols, or any other data communication protocol as will occur to those of skill in the art. The receiving transport engine may provide the received application messages directly to the conversion module (220) or to the messaging middleware (276), which in turn, provides the source stream messages to the conversion module (220).

After the conversion module (220) of FIG. 1 performs data processing on the application messages received from the feed source (213), the conversion module (220) provides the application messages having the second format to the messaging middleware (276). The messaging middleware (276) of FIG. 1 is a software component that provides high availability services between the feed adapter (208), any backup feed adapter that may exist, the subscribing client device (210), and the feed source (213). In addition, the messaging middleware (276) of FIG. 1 also provides administrative services regarding the application messages such as, for example, receiving application messages from the conversion module (220), inserting sequence numbers into the application messages, and providing the received application messages to the transport engine (278) for transmission to a subscribing client device (210) on the feed adapter output stream (216). The conversion module (220) interacts with the messaging middleware (276) through a messaging middleware API (266) exposed by the messaging middleware (276).

The transport engine (278) of FIG. 1 is a software component operating in the transport and network layers of the OSI protocol stack promulgated by the International Organization for Standardization. The transport engine (278) provides data communications services between network-connected devices. The transport engine may be implemented according to the UDP/IP protocols, TCP/IP protocols, or any other data communications protocols as will occur to those of skill in the art. The transport engine (278) is a software module that includes a set of computer program instructions for accessing application message data in a messaging environment according to embodiments of the present invention. The transport engine (278) operates generally for accessing application message data in a messaging environment according to embodiments of the present invention by receiving an application message and the sequence field code for the application message, and accessing the sequence number message field in the application message in dependence upon the sequence field code. The transport engine (278) also transmits the application messages (240) to the subscribing client device (210) by encapsulating the application messages provided by the messaging middleware (276) into transport packets and transmitting the packets through the message stream (280) to the subscribing client device (210). The messaging middleware (276) operates the transport engine (278) through a transport API (268) exposed by the transport engine (278).

The subscribing client device (210) in exemplary system of FIG. 1 connects to the high speed, low latency data communications network (200) through a wireline connection (264). The subscribing client device (210) of FIG. 1 is a computer device capable of subscribing to the message streams transmitted by various feed adapters. In a financial market data environment, for example, a subscribing client device may subscribe to a tick to receive the bid and ask prices for a particular security on a message stream provided by a feed adapter controlled by a financial securities broker.

In the example of FIG. 1, the subscribing client device (210) has installed upon it an application (238), a messaging module (248), a message model (244), messaging middleware (252), a stream administration library (272), and a transport engine (256). The application (238) is a software component that processes data contained in the application messages (240) received from the feed adapter (208). The application (238) may process the data for utilization by the subscribing client device (210) itself, for contributing the data to another feed adapter, or for contributing the data to some other device. In a financial market data environment, the application installed on the subscribing client device may be a program trading application that buys or sells financial securities based on the quoted prices contained in ticks. The application may also be a value-adding application that contributes information to a tick such as, for example, the best bid and ask prices for a particular security, that is not typically included in the ticks provided by the feed source (213). The subscribing client device may then transmit the ticks to a feed adapter for resale to other subscribing client devices.

The application (238) processes the data contained in the application messages (240) using the messaging module (248). The messaging module (248) is software module that includes a set of functions for creating, accessing, and manipulating messages (240) according to the message model (244) that is installed on both the feed adapter (208) and the subscribing client device (210). The messaging module (248) also includes a set of computer program instructions for accessing application message data in a messaging environment according to embodiments of the present invention. The messaging module (248) of FIG. 1 operates generally for accessing application message data in a messaging environment according to embodiments of the present invention by receiving a request for a value from a specific message field of an application message that was created according to the message model (244) without the default message field from a requesting module, determining whether the specific message field is the default message field, and providing the default value specified in the message model (244) to the requesting module if the specific message field is the default message field. The messaging module (248) is accessible to the application (238) through a message API (250) exposed by the messaging module (248).

The communications between the subscribing client device (210) and the stream administration server (212) may be implemented using a stream administration library (272). The stream administration library (272) is a set of functions contained in dynamically linked libraries or statically linked libraries available to the application (238) through a stream administration library API (274). Through the stream administration library (272), the subscribing client device (210) of FIG. 1 may request to subscribe to messages from a feed adapter, modify an existing message subscription, or cancel a subscription. Functions of the stream administration library (272) used by the application (238) may communicate with the stream administration server (212) through network (200) by calling member methods of a CORBA object, calling member methods of remote objects using the Java Remote Method Invocation (‘RMI’) API, using web services, or any other communication implementation as will occur to those of skill in the art.

‘CORBA’ refers to the Common Object Request Broker Architecture, a computer industry specifications for interoperable enterprise applications produced by the Object Management Group (‘OMG’). CORBA is a standard for remote procedure invocation first published by the OMG in 1991. CORBA can be considered a kind of object-oriented way of making remote procedure calls, although CORBA supports features that do not exist in conventional RPC. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages, such as C++ or Java, look like invocations of local member methods in local objects.

The Java™ Remote Method Invocation API is a Java application programming interface for performing remote procedural calls published by Sun Microsystems™. The Java™ RMI API is an object-oriented way of making remote procedure calls between Java objects existing in separate Java™ Virtual Machines that typically run on separate computers. The Java™ RMI API uses a remote procedure object interface to describe remote objects that reside on the server. Remote procedure object interfaces are published in an RMI registry where Java clients can obtain a reference to the remote interface of a remote Java object. Using compiled ‘stubs’ for the client side and ‘skeletons’ on the server side to provide the network connection operations, the Java™ RMI allows a Java client to access a remote Java object just like any other local Java object.

Before the application (238) processes the data contained in the application messages (240), the application (238) receives the messages (240) from the messaging middleware (252), which, in turn, receives the application messages (240) from the feed adapter (208) through the transport engine (256). The messaging middleware (252) is a software component that provides high availability services between the subscribing client device (210), the feed adapter (208), any backup feed adapters, and the stream administration module (212). In addition, the messaging middleware (252) of FIG. 1 also provides administrative services regarding the application messages such as, for example, filtering application message received from the feed adapter (208) according to constraints provided by the stream administration server (212). The application (238) and the stream administration library (272) interact with the messaging middleware (252) through a messaging middleware API (254).

The transport engine (256) of FIG. 1 is a software component operating in the transport and network layers of the OSI protocol stack promulgated by the International Organization for Standardization. The transport engine (256) provides data communications services between network-connected devices. The transport engine may be implemented according to the UDP/IP protocols, TCP/IP protocols, or any other data communications protocols as will occur to those of skill in the art. The transport engine (256) is a software component that includes a set of computer program instructions configured for accessing application message data in a messaging environment according to embodiments of the present invention. The transport engine (256) operates generally for accessing application message data in a messaging environment according to embodiments of the present invention by receiving the application message and the sequence field code from the message sending device, and accessing the sequence number message field in the application message in dependence upon the sequence field code. In the example of FIG. 1, the messaging middleware (252) operates the transport engine (256) through a transport API (258) exposed by the transport engine (256).

The servers and other devices illustrated in the exemplary system of FIG. 1 are for explanation, not for limitation. Devices useful in accessing application message data in a messaging environment may be implemented using general-purpose computers, such as, for example, computer servers or workstations, hand-held computer devices, such as, for example, Personal Digital Assistants (‘PDAs’) or mobile phones, or any other automated computing machinery configured for data processing according to embodiments of the present invention as will occur to those of skill in the art.

The arrangement of servers and other devices making up the exemplary system illustrated in FIG. 1 are for explanation, not for limitation. Although the connections to the network (200) of FIG. 1 are depicted and described in terms of wireline connections, readers will note that wireless connections may also be useful according to various embodiments of the present invention. Furthermore, data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example Transmission Control Protocol (‘TCP’), Internet Protocol (‘IP’), HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 1.

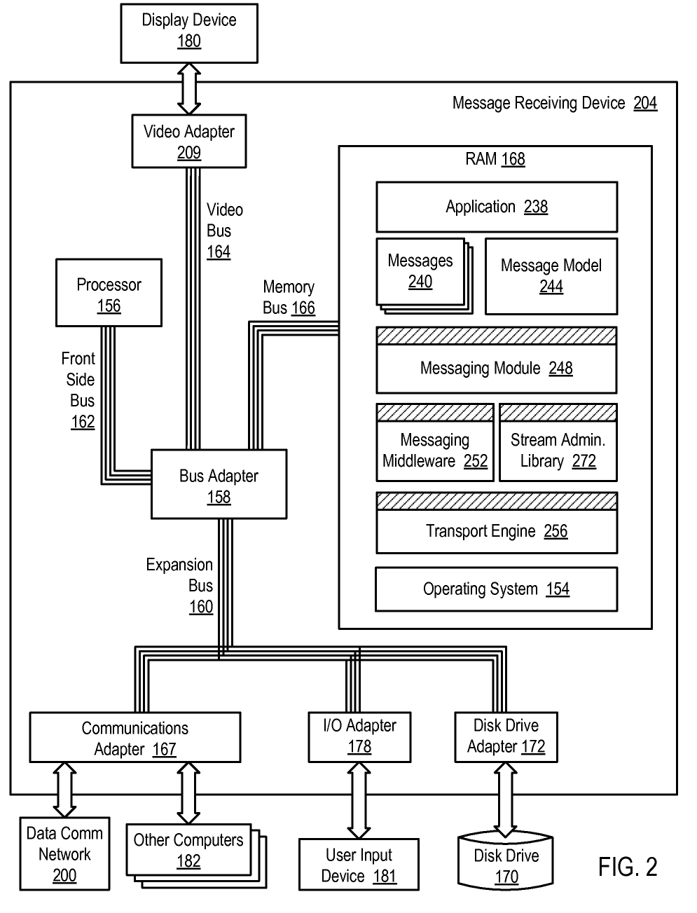

Accessing application message data in a messaging environment in accordance with the present invention in some embodiments may be implemented with one or more message receiving devices, stream administration servers, and feed adapters. These devices and servers are, in turn, implemented to some extent at least as computers, that is, automated computing machinery. For further explanation, therefore, FIG. 2 sets forth a block diagram of automated computing machinery comprising an exemplary message receiving device (204) useful in accessing application message data in a messaging environment according to embodiments of the present invention. The message receiving device (204) of FIG. 2 includes at least one computer processor (156) or ‘CPU’ as well as random access memory (168) (‘RAM’) which is connected through a high speed memory bus (166) and bus adapter (158) to processor (156) and to other components of the message receiving device.

Stored in RAM (168) is an application (238), messages (240), message model (244), a messaging module (248), a messaging middleware (252) a stream administration library (272), and a transport engine (256). Each message (240) is a quantity of data that includes one or more data fields and is transmitted from one device to another on a message stream. As mentioned above, a message may represent numeric or textual information, images, encrypted information, computer program instructions, and so on. In a financial market data environment, for example, a message is commonly referred to as a ‘tick’ and represents financial market data such as, for example, financial quotes or financial news. Each message (240) may be implemented using a structured document such as, for example, an XML document, a Java object, C++ object, or any other implementation as will occur to those of skill in the art. The message model (244) is metadata that defines the structure and format of the messages (240). The message model (244) may also be implemented using a structured document such as, for example, an XML document, a Java object, C++ object, or any other implementation as will occur to those of skill in the art. The application (238), the messaging module (248), the messaging middleware (252), the stream administration library (272), and the transport engine (256) illustrated in FIG. 2 are software components, that is computer program instructions, that operate as described above with reference to FIG. 1.

Also stored in RAM (168) is an operating system (154). Operating systems useful in message receiving devices according to embodiments of the present invention include UNIX™, Linux™, Microsoft NT™, IBM's AIX™, IBM's i5/OS™, and others as will occur to those of skill in the art. The operating system (154), the application (238), the messages (240), the message model (244), the messaging module (248), the stream administration library (272), the messaging middleware (252), and the transport engine (256) in the example of FIG. 2 are shown in RAM (168), but many components of such software typically are stored in non-volatile memory also, for example, on a disk drive (170).

The exemplary message receiving device (204) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in message receiving devices useful according to embodiments of the present invention include the Intel Northbridge, the Intel Memory Controller Hub, the Intel Southbridge, and the Intel I/O Controller Hub. Examples of expansion buses useful in message receiving devices useful according to embodiments of the present invention may include Peripheral Component Interconnect (‘PCI’) buses and PCI Express (‘PCIe’) buses.

The exemplary message receiving device (204) of FIG. 2 also includes disk drive adapter (172) coupled through expansion bus (160) and bus adapter (158) to processor (156) and other components of the exemplary message receiving device (204). Disk drive adapter (172) connects non-volatile data storage to the exemplary message receiving device (204) in the form of disk drive (170). Disk drive adapters useful in message receiving devices include Integrated Drive Electronics (‘IDE’) adapters, Small Computer System Interface (‘SCSI’) adapters, and others as will occur to those of skill in the art. In addition, non-volatile computer memory may be implemented for a message receiving device as an optical disk drive, electrically erasable programmable read-only memory (so-called ‘EEPROM’ or ‘Flash’ memory), RAM drives, and so on, as will occur to those of skill in the art.

The exemplary message receiving device (204) of FIG. 2 includes one or more input/output (‘I/O’) adapters (178). I/O adapters in message receiving devices implement user-oriented input/output through, for example, software drivers and computer hardware for controlling output to display devices such as computer display screens, as well as user input from user input devices (181) such as keyboards and mice. The exemplary message receiving device (204) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary message receiving device (204) of FIG. 2 includes a communications adapter (167) for data communications with other computers (182) and for data communications with a high speed, low latency data communications network (200). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for accessing application message data in a messaging environment according to embodiments of the present invention include modems for wired dial-up communications, IEEE 802.3 Ethernet adapters for wired data communications network communications, and IEEE 802.11b adapters for wireless data communications network communications.

Although FIG. 2 is discussed with reference to exemplary message receiving devices, readers will note that automated computing machinery used to implement exemplary stream administration servers and exemplary message sending devices useful in accessing application message data in a messaging environment according to embodiments of the present invention are similar to the exemplary message receiving device (204) of FIG. 2. That is, such exemplary stream administration servers and message sending devices include one or more processors, bus adapters, buses, RAM, video adapters, communications adapters, I/O adapters, disk drive adapters, and other components similar to the exemplary message receiving device (204) of FIG. 2 as will occur to those of skill in the art.

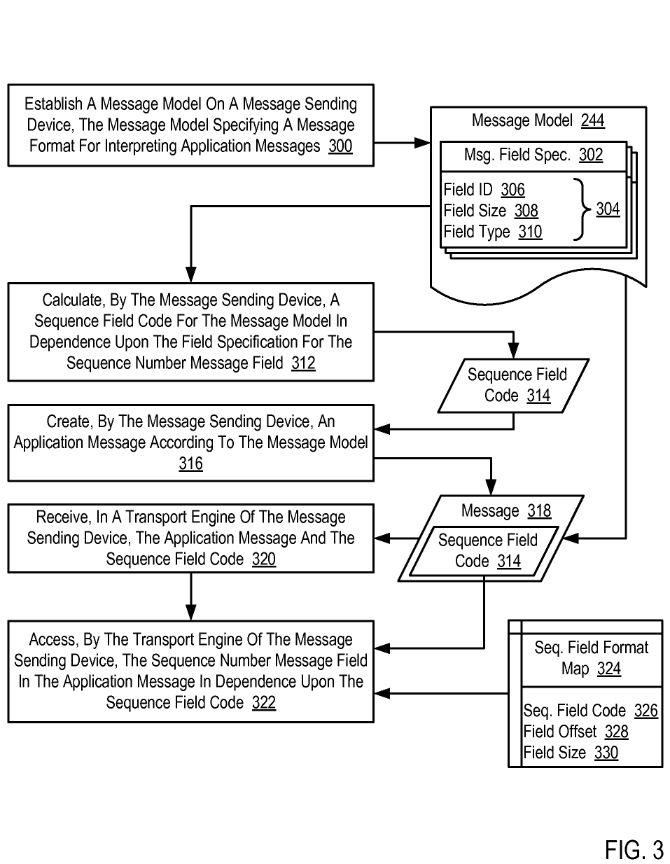

For further explanation, FIG. 3 sets forth a flowchart illustrating an exemplary method for accessing application message data in a messaging environment according to embodiments of the present invention. The method of FIG. 3 includes establishing (300) a message model (244) on a message sending device. The message model (244) is metadata that defines the structure and the format used to create, access, and manipulate application messages on the message sending device. That is, the message model (244) specifies a message format for interpreting application messages. The message model (244) of FIG. 3 includes one or more field specifications (302). Each field specification (302) is metadata that specifies a message field for an application message, typically, for storing data in the application message. Each field specification (302) of FIG. 3 includes field characteristics (304). Field characteristics (304) describe the attributes of the message field in an application message. In the example of FIG. 3, the field characteristics (304) of each field specification (302) include a field identifier (306), a field size (308), and field type (310). The field identifier (306) specifies a unique identifier for each field specified by the field specifications (302). The field size (308) specifies the size of each field specified by the field specifications (302). The field type (310) specifies the type of each field specified by the field specifications (302).

In the example of FIG. 3, at least one of the field specifications (302) specifies a sequence number message field for storing a sequence number in each of the application messages. A sequence number uniquely identifies the application message among other application messages transmitted from a particular message sending device. A sequence number also provides the relative transmission order for a particular application message with respect to the other application messages transmitted from the message sending device.

The method of FIG. 3 includes calculating (312), by the message sending device, a sequence field code (314) for the message model (244) in dependence upon the field specification (302) for the sequence number message field. The sequence field code (314) represents a value that indicates the particular field characteristics for the sequence number message field specified in the message model. Using the sequence field code, a transport engine may identify the field characteristics for the sequence number message field of an application message without having to access the message model (244). Bypassing the message model (244) advantageously allows the transport engine to directly access the sequence number message field of an application message and increases system performance. The message sending device may calculate (312) the sequence field code (314) for the message model (244) according to the method of FIG. 3 by concatenating, into a string, the values specified by the field characteristics (304) of the field specification (302) for the sequence number message field and executing a hash function, such as, for example, cyclic redundancy check (‘CRC’), with the string to produce a checksum. The message sending device may use the value of the checksum as the value for the sequence field code (314).

The method of FIG. 3 also includes creating (316), by the message sending device, an application message (318) according to the message model (244). The message sending device may create (316) an application message (318) according to the message model (244) according to the method of FIG. 3 by generating a generic application message based on the message model (244) that includes all of the default and constant values specified by the message model, storing the sequence field code (314) in the header of the generic application message, and copying the application message (318) from the generic application message generated from the message model (244). Although from the description above readers will note that the sequence field code (314) is stored in the application message (318), such a description is for explanation and not for limitation.

The method of FIG. 3 includes receiving (320), in a transport engine of the message sending device, the application message (318) and the sequence field code (314). The transport engine of the message sending device may receive (320) the application message (318) and the sequence field code (314) according to the method of FIG. 3 by receiving a pointer to a block of computer memory used to store the application message in response a software component's call to a function of the transport engine's API.

The method of FIG. 3 also includes accessing (322), by the transport engine of the message sending device, the sequence number message field in the application message (318) in dependence upon the sequence field code (314). The transport engine of the message sending device may access (322) the sequence number message field in the application message (318) according to the method of FIG. 3 by retrieves the value for the sequence field code (314) from a predetermined location in the application message, identifying the position and size of the sequence number message field in the application message (318) from a sequence field format map (324) using the sequence field code (314), and reading or writing a value at the sequence number message field in the application message (318). The sequence field format map (324) of FIG. 3 is a table in the transport engine that specifies format characteristics of a sequence number message field for a particular sequence field code. In the example of FIG. 3, each record of the sequence field format map (324) includes a sequence field code (326), a field offset (328), and a field size (330).

Although FIG. 3 is described using only a single message model (244), often a transport engine receives application messages created using a variety of message models. Each message model may specify different field characteristics for the sequence number message field included in the application messages. In addition, a message model may specify more than one message format in the model, and each message format may specify different field characteristics for the sequence number message field. As a result, more than one field specification often exists for the sequence number message field. For example, one sequence number message field specification may specify that the sequence number message field is located at an offset of ‘4h’ from the beginning of the application message and have a size of ‘4h.’ Another specification may specify that the sequence number message field is located at an offset of ‘2h’ from the beginning of the application message and have a size of ‘8h.’

For each sequence number field specification, the transport engine may maintain an entry in the sequence field format map (324). For example, one record of the sequence field format map (324) of FIG. 3 may specify an offset value of ‘4h’ and a size of ‘4h’ for a sequence field code value of ‘0,’ and another record of the sequence field format map (324) may specify an offset value of ‘2h’ and a size of ‘8h’ for a sequence field code value of ‘1’ Using the field offset (328) and the field size (330) specified in the sequence field format map (324), the transport engine may directly access the sequence number message field to read or write a value into the sequence number field. To keep the sequence field format map (324) current, a messaging module may update the sequence field format map (324) to reflect any changes to the message models or sequence number message field specifications.

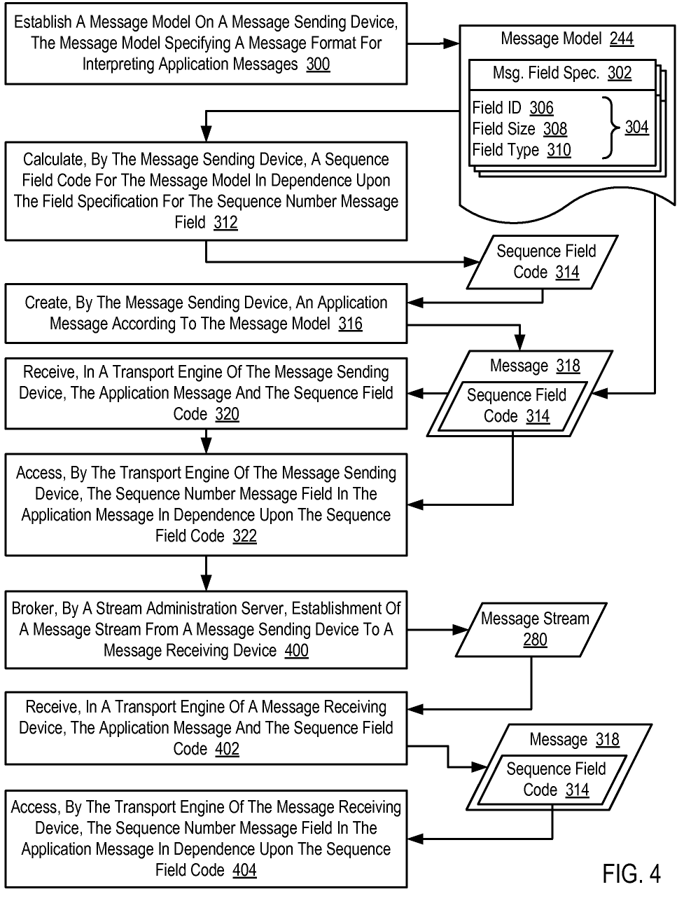

In the method of FIG. 3, the transport engine of a message sending device accesses the sequence number message field of the application message. After the message sending device transmits the application message to the message receiving device, the transport engine of the message receiving device may also access the sequence number message field of the application message. For further explanation, therefore, FIG. 4 sets forth a flowchart illustrating a further exemplary method for accessing application message data in a messaging environment according to embodiments of the present invention that includes accessing (404), by the transport engine of the message receiving device, the sequence number message field in the application message in dependence upon the sequence field code (314).

The method of FIG. 4 is similar to the method of FIG. 3. That is, the method of FIG. 4 includes establishing (300) a message model (244) on a message sending device. The message model (244) specifies a message format for interpreting application messages and includes one or more field specifications (302). Each field specification (302) specifies a message field for storing data in the application messages and includes field characteristics (304) such as a field identifier (306), field size (308), and field type (310). At least one of the field specifications (302) specifies a sequence number message field for storing a sequence number in each of the application messages. The method of FIG. 4 is also similar to the method of FIG. 3 in that the method of FIG. 4 includes calculating (312), by the message sending device, a sequence field code (314) for the message model in dependence upon the field specification (302) for the sequence number message field, creating (316), by the message sending device, an application message (318) according to the message model (244), receiving (320), in a transport engine of the message sending device, the application message (318) and the sequence field code (314), and accessing (322), by the transport engine of the message sending device, the sequence number message field in the application message in dependence upon the sequence field code (314).

The method of FIG. 4 also includes brokering (400), by a stream administration server, establishment of a message stream (280) from the message sending device to a message receiving device. The message stream (280) of FIG. 4 provides the application messages to the message receiving device from the message sending device. The message stream (280) of FIG. 4 represents a data communication channel between a communications endpoint of a message receiving device and a communications endpoint of a message sending device. A message stream may be implemented as a multicast data communication channel using the UDP/IP protocols or a unicast data communication channel using TCP/IP protocols as discussed above with reference to FIG. 1.

Brokering (400), by a stream administration server, establishment of a message stream (280) from the message sending device to a message receiving device according to the method of FIG. 4 may be carried out by receiving a subscription request from the message receiving device to subscribe to messages from the message sending device. The subscription request may be implemented as an XML document, a call to a member method of a RMI object on the message receiving device, or any other implementation as will occur to those of skill in the art. The subscription request may include topics of the application messages that the message receiving device requests to receive from the message sending device. A topic represents the characteristics of the messages that the message receiving device requests. Using a topic, a message receiving device may specify the group of messages for receipt from the message sending device. In a financial market data environment, for example, a message receiving device may use a topic to request ticks from an OPRA feed source that contains quotes of an IBM option traded on the Chicago Board Options Exchange (‘CBOE’) that includes the best bid and best ask for the IBM option on the CBOE.

In the example of FIG. 4, brokering (400), by a stream administration server, establishment of a message stream (280) from the message sending device to a message receiving device may also include providing the message receiving device with a destination address for the message sending device. The destination address for the message sending device is a multicast address or a unicast address used by the message receiving device to listen for messages from a message sending device. Using the destination address provided by the stream administration server, the message receiving device may establish the message stream (280) from the message sending device to the message receiving device.

Before the stream administration server provides the destination address for the message sending device, the stream administration server in the example of FIG. 4 may perform several security services to ensure that the message receiving device only receives messages from the message sending device for which the message receiving device is authorized to receive. In the method of FIG. 4, brokering (400), by a stream administration server, establishment of a message stream (280) from the message sending device to a message receiving device may also be carried out by authenticating the message receiving device and authorizing the message receiving device to receive messages from the message sending device on the message stream (280). Authenticating the message receiving device may be carried out by verifying client security credentials provided by the message receiving device with the subscription request. The client security credentials may be implemented as a digital signature in a public key infrastructure, a security token, or any other security data as will occur to those of skill in the art for authenticating the identity of the originator of the subscription request. Authorizing the message receiving device to receive messages from the message sending device on the message stream (280) may be carried out by identifying the privileges associated with the authenticated message receiving device in dependence upon an authorization policy. An authorization policy is a set of rules governing the privileges of authenticated message receiving devices requesting to receive data from a message sending device.

The method of FIG. 4 includes receiving (402), in a transport engine of a message receiving device from the message sending device, the application message (318) and the sequence field code (314). The transport engine of the message receiving device may receive (402) the application message (318) and the sequence field code (314) from the message sending device according to the method of FIG. 4 by receiving transport packets from the message sending device and unencapsulating the application message (318) and the sequence field code (314) from the transport packets. The transport engine of the message receiving device may receive the transport packets from the message sending device through a data communications channel implemented according to the TCP/IP protocols, the UDP/IP protocols, or any other data communications protocols as will occur to those of skill in the art.

The method of FIG. 4 also includes accessing (404), by the transport engine of the message receiving device, the sequence number message field in the application message in dependence upon the sequence field code (314). The transport engine of the message receiving device may access (404) the sequence number message field in the application message in dependence upon the sequence field code (314) in a manner similar to the transport engine of the message sending device accessing the sequence number message field in the application message.

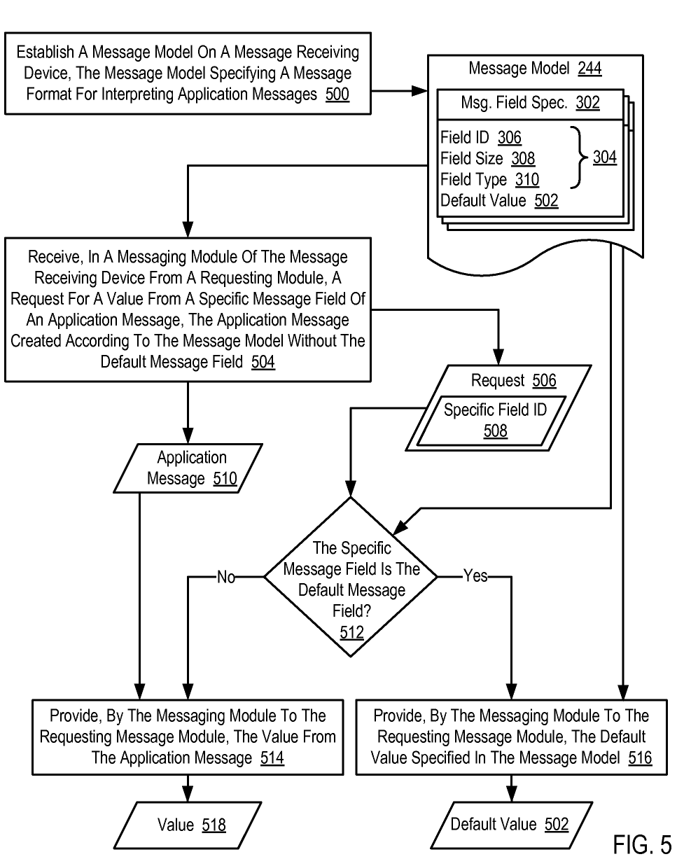

As described above, an application message transmitted from a message sending device to a message receiving device typically does not include the metadata describing the message format used to interpret the application message. Instead, such metadata is stored in message models that are established on the message sending device and the message receiving device. Storing this metadata in the message models instead of the application messages themselves advantageously reduces the size of the application messages and reduces the transmission of redundant data across the network. Reducing the size of the application messages and the transmission of redundant data increases the number of application message that may be transmitted using a fixed quantity of network resources. The size of application messages and the transmission of redundant data may be further reduced by storing constant values and default values for the fields of application messages in the message models instead of storing those values in the application messages themselves. For further explanation, therefore, FIG. 5 sets forth a flowchart illustrating a further exemplary method for accessing application message data in a messaging environment according to embodiments of the present invention in which at least one field specification (302) of the message model (244) specifies a default message field.

The method of FIG. 5 includes establishing (500) a message model on a message receiving device. The message model (244) specifies a message format for interpreting application messages and includes one or more field specifications. Each field specification (302) specifies a message field for storing data in the application messages and includes field characteristics (304) for the message field such as a field identifier (306), a field size (308), and a field type (310). In the example of FIG. 5, at least one field specification (302) specifies a default message field, and the field characteristics (304) for the default message field specify a default value (502).

The method of FIG. 5 also includes receiving (504), in a messaging module of the message receiving device from a requesting module, a request (506) for a value from a specific message field of an application message (510). The application message (510) of FIG. 5 was created by a messaging module according to the message model (244) without the default message field to reduce the size of the application message (510). In the example of FIG. 5, the specific message field is identified in the request (506) using a specific field identifier (508). The request (506) for a value from a specific message field of the message (510) may be implemented as an XML document, a call to a function of an API for the messaging module, or any other implementation as will occur to those of skill in the art. For example, consider the following exemplary function in the API of the messaging module useful for receiving a request for a value from a specific message field of an application message according to embodiments of the present invention:
value request_value(message*msg, int field_id);

A requesting module may call the exemplary function ‘request_value’ above to request a value from the application message located at computer memory address identified by the value of ‘msg.’ The specific message field for which the value is requested is identified by the field identifier having a value that matches the value for ‘field_id.’ The exemplary function ‘request_value’ returns the value for the specific message field in the application message after executing the function. Readers will note that the exemplary function described above is for explanation and not for limitation. In fact, other exemplary functions as will occur to those of skill in the art may also be useful in accessing application message data in a messaging environment according to embodiments of the present invention.

The method of FIG. 5 includes determining (512), by the messaging module, whether the specific message field is the default message field. The message module may determine (512) whether the specific message field is the default message field according to the method of FIG. 5 by comparing the specific field identifier (508) with the field identifier (306) included in the message field specification (302) for the default message field in the message model (244). If the specific field identifier (508) matches the field identifier (306), then the specific message field is the default message field. The specific message field is not the default message field, however, if the specific field identifier (508) does not match the field identifier (306).

The method of FIG. 5 includes providing (514), by the messaging module to the requesting module, the value (518) from the application message (510) if the specific message field is not the default message field. The messaging module may provide (514) the value (518) from the application message (510) to the requesting module according to the method of FIG. 5 by retrieving the value (518) from the application message (510) using the field characteristics for the specified message field in the request (506) and transmitting the value (518) to the requesting module. The messaging module may transmit the value (518) to the requesting module by transmitting the value (518) to the requesting module as a return value from a function called by the requesting module as in the exemplary ‘request_value’ function above, sending the value (518) to the requesting module in an XML message using web services, or any other implementation as will occur to those of skill in the art.

The method of FIG. 5 includes providing (516), by the messaging module to the requesting module, the default value (502) specified in the message model (244) if the specific message field is the default message field. The messaging module may provide (516) the default value (502) specified in the message model (244) to the requesting module according to the method of FIG. 5 by retrieving the default value (502) from the field specification in the message model (244) identified using the specific field identifier (508) and transmitting the default value (502) to the requesting module. The messaging module may transmit the default value (502) to the requesting module by transmitting the default value (502) to the requesting module as a return value from a function called by the requesting module as in the exemplary ‘request_value’ function above, sending the default value (502) to the requesting module in an XML message using web services, or any other implementation as will occur to those of skill in the art.

The description above with reference to FIG. 5 is discussed in terms of a default message field and field characteristics for the default message field that specify a default value. Readers will note, however, that the default message field may be implemented as a constant message field and that a default value may be implemented as a constant value. Regardless of whether the default message field is implemented as a constant message field and the default value is implemented as a constant value, the method of FIG. 5 operates in same manner as described above.

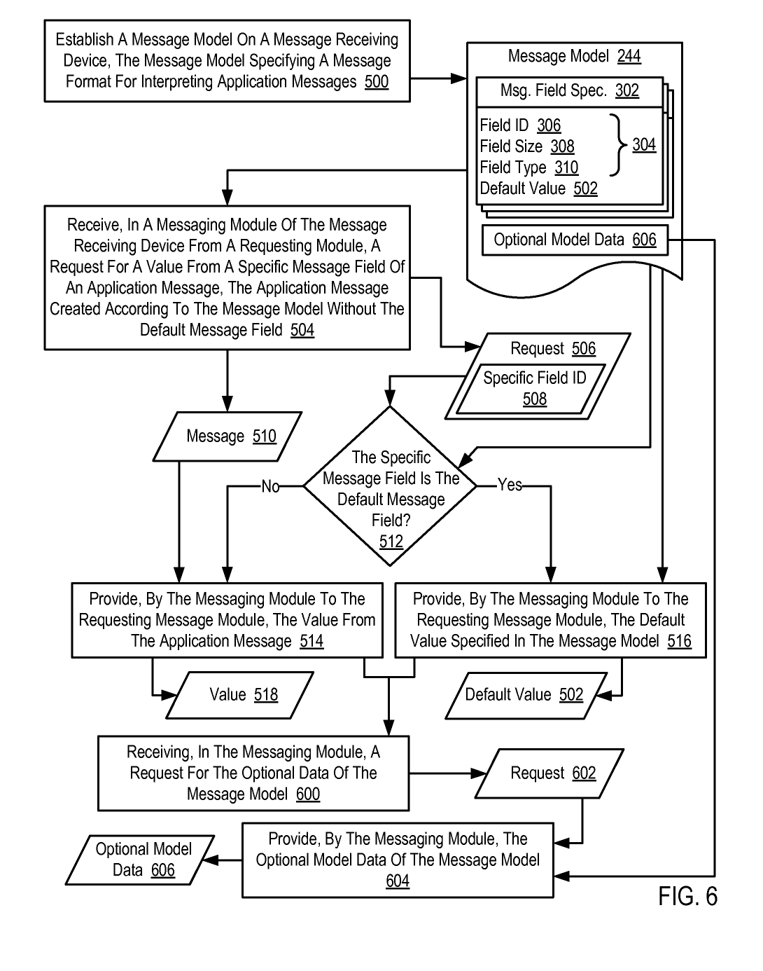

As mentioned above, the message model includes message field specifications that specify message fields for storing data in the application messages. Such message field specifications are typically utilized by a messaging module to provide access to application messages for requesting modules. In addition to the message field specifications, the message model may also include optional model data that is not used by the messaging module to provide access to application messages for requesting modules. Rather, such optional model data may merely describe the message model or the message fields specified by the model without providing any additional information used by the messaging module to access application messages. For further explanation, therefore, FIG. 6 sets forth a flowchart illustrating a further exemplary method for accessing application message data in a messaging environment according to embodiments of the present invention in which the message model further includes optional model data (606).

The method of FIG. 6 is similar to the method of FIG. 5. That is, the method of FIG. 6 includes establishing (500) a message model on a message receiving device. The message model (244) specifies a message format for interpreting application messages and includes one or more field specifications. Each field specification (302) specifies a message field for storing data in the application messages and includes field characteristics (304) such as a field identifier (306), a field size (308), and a field type (310). In the example of FIG. 6, at least one field specification (302) specifies a default message field. The field characteristics (304) for the default message field specify a default value (502). The method of FIG. 6 is also similar to the method of FIG. 5 in that the method of FIG. 6 includes receiving (504), in a messaging module of the message receiving device from a requesting module, a request (506) for a value from a specific message field of an application message (510) that was created according to the message model (244) without the default message field, determining (512), by the messaging module, whether the specific message field is the default message field, providing (514), by the messaging module to the requesting module, the value (518) from the application message (510) if the specific message field is not the default message field, and providing (516), by the messaging module to the requesting module, the default value (502) specified in the message model (244) if the specific message field is the default message field.

In the example of FIG. 6, the message model (244) also includes optional model data (606). The optional model data (606) describes the message model (244) or the message fields specified in the message model (244), but such data (606) is not used by the messaging module to access application messages. Although the optional model data (606) is not used by the messaging model to access application messages, the optional model data (606) is stored in the message model (244) because of the desirability of keeping information about the model (244) with the model (244). An example of optional model data (606) may include descriptions of the message fields specified in the model (244). Such exemplary model data may be useful for documentation of the message model (244) or development tools.

The method of FIG. 6 includes receiving (600), in the messaging module of the message receiving device from the requesting module, a request (602) for the optional model data (606) of the message model (244). The request (602) for the optional model data (606) of the message model (244) of FIG. 6 may be implemented as an XML document received using web services, a call to a function of an API for the messaging module, or any other implementation as will occur to those of skill in the art. For example, consider the following exemplary function in the API of the messaging module useful for receiving a request for the optional model data of the message model according to embodiments of the present invention:
model_data request_model_data(int model_id, int model_data_id);

A requesting module may call the exemplary function ‘request_model_data’ above to request the optional model data from the message model identified by the value of ‘model_id.’ The specific optional model data that is requested is identified by the optional model data identifier having a value that matches the value for ‘model_data_id.’ The exemplary function ‘request_model_data’ returns the optional model data for the specific message model after executing the function. Readers will note that the exemplary function described above is for explanation and not for limitation. In fact, other exemplary functions as will occur to those of skill in the art may also be useful in accessing application message data in a messaging environment according to embodiments of the present invention.

The method of FIG. 6 also includes providing (604), by the messaging module of the message receiving device to the requesting module, the optional model data (606) of the message model (244). The messaging module may provide (604) the optional model data (606) of the message model (244) to the requesting module according to the method of FIG. 6 by identifying the location of the optional model data (606) in the header of the message model (244), retrieving the optional model data (606) from the message model (244), and transmitting the optional model data (606) to the requesting module. The messaging module may transmit the optional model data (606) to the requesting module by transmitting the optional model data (606) to the requesting module as a return value from a function called by the requesting module as in the exemplary ‘request_model_data’ function above, sending the optional model data (606) to the requesting module in an XML message using web services, or any other implementation as will occur to those of skill in the art.

In view of the explanations set forth above in this document, readers will recognize that accessing application message data in a messaging environment according to embodiments of the present invention provides the following benefits:
provides the ability for a transport layer software component to access a sequence number message field in an application message without increasing the size or complexity of a transport layer wrapper containing the application message, and
provides the ability to reduce the size of application messages and the transmission of redundant data in a messaging environment by storing default and constant values for application messages in the message model.

Exemplary embodiments of the present invention are described largely in the context of a fully functional computer system for accessing application message data in a messaging environment. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of accessing application message data in a messaging environment, the method comprising:
establishing a message model on a message sending device, the message model specifying a message format for interpreting application messages, the message model comprising one or more field specifications, each field specification specifying a message field for storing data in the application messages, each field specification comprising field characteristics, at least one of the field specifications specifies a sequence number message field for storing a sequence number in each of the application messages;
calculating, by the message sending device, a sequence field code for the message model in dependence upon the field specification for the sequence number message field;
creating, by the message sending device, an application message according to the message model;
receiving, in a transport engine of the message sending device, the application message and the sequence field code; and
accessing, by the transport engine of the message sending device, the sequence number message field in the application message in dependence upon the sequence field code.

2. The method of claim 1 further comprising:
receiving, in a transport engine of a message receiving device from the message sending device, the application message and the sequence field code; and
accessing, by the transport engine of the message receiving device, the sequence number message field in the application message in dependence upon the sequence field code.

3. The method of claim 1 further comprising brokering, by a stream administration server, establishment of a message stream from the message sending device to a message receiving device, the message stream providing the application messages to the message receiving device from the message sending device.

4. The method of claim 1 wherein the messaging environment is a financial market data environment and wherein the application messages comprise financial market data.

5. A method of accessing application message data in a messaging environment, the method comprising:
establishing a message model on a message receiving device, the message model specifying a message format for interpreting application messages, the message model comprising one or more field specifications, each field specification specifying a message field for storing data in the application messages, each field specification comprising field characteristics, at least one field specification specifies a default message field, the field characteristics for the default message field specify a default value;
receiving, in a messaging module of the message receiving device from a requesting module, a request for a value from a specific message field of an application message, the application message created according to the message model without the default message field;
determining, by the messaging module, whether the specific message field is the default message field; and
providing, by the messaging module to the requesting module, the default value specified in the message model if the specific message field is the default message field.

6. The method of claim 5 wherein:
the default message field is a constant message field; and
the default value is a constant value.

7. The method of claim 5 wherein the message model further comprises optional model data, the optional model data describing the message model or the message fields specified in the message model, the method further comprising:
receiving, in the messaging module of the message receiving device from the requesting module, a request for the optional model data of the message model; and
providing, by the messaging module of the message receiving device to the requesting module, the optional model data of the message model.

8. The method of claim 5 wherein the messaging environment is a financial market data environment and wherein the application messages comprise financial market data.

9. A system for accessing application message data in a messaging environment, the system comprising one or more computer processors, computer memory operatively coupled to the one or more computer processors, the computer memory having disposed within it computer program instructions capable of:
establishing a message model on a message sending device, the message model specifying a message format for interpreting application messages, the message model comprising one or more field specifications, each field specification specifying a message field for storing data in the application messages, each field specification comprising field characteristics, at least one of the field specifications specifies a sequence number message field for storing a sequence number in each of the application messages;
calculating, by the message sending device, a sequence field code for the message model in dependence upon the field specification for the sequence number message field;
creating, by the message sending device, an application message according to the message model;
receiving, in a transport engine of the message sending device, the application message and the sequence field code; and
accessing, by the transport engine of the message sending device, the sequence number message field in the application message in dependence upon the sequence field code.

10. The system of claim 9 further comprising computer program instructions capable of:
receiving, in a transport engine of a message receiving device from the message sending device, the application message and the sequence field code; and
accessing, by the transport engine of the message receiving device, the sequence number message field in the application message in dependence upon the sequence field code.

11. The system of claim 9 further comprising computer program instructions capable of brokering, by a stream administration server, establishment of a message stream from the message sending device to a message receiving device, the message stream providing the application messages to the message receiving device from the message sending device.

12. The system of claim 9 wherein the messaging environment is a financial market data environment and wherein the application messages comprise financial market data.

13. The system of claim 9 wherein at least one field specification specifies a default message field, the field characteristics for the default message field specify a default value, the system further comprising computer program instructions capable of:
receiving, in a messaging module of the message receiving device from a requesting module, a request for a value from a specific message field of an application message, the application message created according to the message model without the default message field;
determining, by the messaging module, whether the specific message field is the default message field; and
providing, by the messaging module to the requesting module, the default value specified in the message model if the specific message field is the default message field.

14. The system of claim 9 wherein the message model further comprises optional model data, the optional model data describing the message model or the message fields specified in the message model, the system further comprising computer program instructions capable of:
receiving, in the messaging module of the message receiving device from the requesting module, a request for the optional model data of the message model; and
providing, by the messaging module of the message receiving device to the requesting module, the optional model data of the message model.

15. A computer program product for accessing application message data in a messaging environment, the computer program product disposed upon a recordable medium, the computer program product comprising computer program instructions capable of:
establishing a message model on a message sending device, the message model specifying a message format for interpreting application messages, the message model comprising one or more field specifications, each field specification specifying a message field for storing data in the application messages, each field specification comprising field characteristics, at least one of the field specifications specifies a sequence number message field for storing a sequence number in each of the application messages;
calculating, by the message sending device, a sequence field code for the message model in dependence upon the field specification for the sequence number message field;
creating, by the message sending device, an application message according to the message model;
receiving, in a transport engine of the message sending device, the application message and the sequence field code; and
accessing, by the transport engine of the message sending device, the sequence number message field in the application message in dependence upon the sequence field code.

16. The computer program product of claim 15 further comprising computer program instructions capable of:
receiving, in a transport engine of a message receiving device from the message sending device, the application message and the sequence field code; and
accessing, by the transport engine of the message receiving device, the sequence number message field in the application message in dependence upon the sequence field code.

17. The computer program product of claim 15 further comprising computer program instructions capable of brokering, by a stream administration server, establishment of a message stream from the message sending device to a message receiving device, the message stream providing the application messages to the message receiving device from the message sending device.

18. The computer program product of claim 15 wherein the messaging environment is a financial market data environment and wherein the application messages comprise financial market data.

19. The computer program product of claim 15 wherein at least one field specification specifies a default message field, the field characteristics for the default message field specify a default value, the computer program product further comprising computer program instructions capable of:
receiving, in a messaging module of the message receiving device from a requesting module, a request for a value from a specific message field of an application message, the application message created according to the message model without the default message field;
determining, by the messaging module, whether the specific message field is the default message field; and
providing, by the messaging module to the requesting module, the default value specified in the message model if the specific message field is the default message field.

20. The computer program product of claim 15 wherein the message model further comprises optional model data, the optional model data describing the message model or the message fields specified in the message model, the computer program product further comprising computer program instructions capable of:
receiving, in the messaging module of the message receiving device from the requesting module, a request for the optional model data of the message model; and
providing, by the messaging module of the message receiving device to the requesting module, the optional model data of the message model.
